(19) United States
(12) Patent Application Publication
(10) Pub. No.: US 2010/0004343 A1
(43) Pub. Date: Jan. 7, 2010

(54) Disinfectant and sanitizer for cosmetics and cosmetic tools

(76) Inventors: Nancy Crossley, Toronto (CA); Gord Connely, Toronto (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 12/311,128

(22) PCT Filed: Sep. 17, 2007
(86) PCT No.: PCT/CA2007/001643

§ 371 Date: Mar. 19, 2009

(30) Foreign Application Priority Data
Sep. 19, 2006 (CA) 2560138

(51) Int. Cl. A01N 31/02; A01P 1/00

(52) U.S. Cl. 514/724

(57) ABSTRACT

The present invention provides a disinfectant and sanitizer composition for application to cosmetics and cosmetic tools, which composition comprises: ethyl alcohol; and one or more conditioners selected from the group consisting of isopropyl palmitate, caprylic triglyceride, capric triglyceride, isopropyl myristate, and alkylbenzoate.

### BACKGROUND OF THE INVENTION

1. Field of the Invention

The invention lies in the field of sanitizers and disinfectants for cosmetics and cosmetic tools.

2. Prior Art

One of the problems of society today is the ease with which diseases can be spread by way of use of a product by many persons without the product being cleaned between respective uses and also multiple uses of a product by the same person without the product being cleaned between the respective uses. Surfaces of products act as breeding grounds for various mircoorganisms which can be spread very easily from person to person by contact with the surface of the product without the necessary steps being taken to disinfect or sanitize the surface of the product between multiples users. Similarly, if a single person does not disinfect or sanitize a product which that person uses on a multiple basis, microorganisms may well grow on the surface of that product and may infect the person using the product after subsequent uses.

One prime example of such a problem is in the cosmetic field. Both cosmetics and cosmetic tools act as a breeding ground for microorganisms including bacteria and the like. Most persons who use cosmetics and cosmetic tools never clean the cosmetics or the cosmetic tools and as a result, microorganisms can transfer very easily from the cosmetic or the cosmetic tool to the user of such products.

Further, in retail establishments, many cosmetics are sampled by the consumer and there is no attempt by the retail establishment to clean the cosmetics or the cosmetic tools which are repeatedly used by different consumers. As a result, microorganisms which breed on the cosmetics and the cosmetic tools can be easily transferred to the consumer. A further problem is that microorganisms which are found on the consumer may be transferred by the use of the sample cosmetic or the cosmetic tool to that cosmetic or that cosmetic tool which in turn will transfer the microorganisms to a second consumer thus spreading the disease amongst all the consumers who use such products. Few attempts are made by the retail establishments to determine whether or not microorganisms are breeding on the cosmetics or the cosmetic tools and if so, no effective attempt is made to disinfect or to sanitize such cosmetic or cosmetic tools.

It is known that cosmetics and cosmetic tools carry a very large number of microorganisms including germs and pathogens, especially bacteria, on the surface. This phenomenon is of particular importance in the case of articles which are constantly touched by different persons without the germs being killed immediately.

Although various cosmetic products do include antimicrobials in the formulation and while there are disinfectants available, these are not effective for several reasons. First, not all cosmetics include antimicrobials. Further, cosmetic tools cannot be made with antimicrobials. Further, in many cases, the consumer does not have easy access to the disinfectant or sanitizer and the disinfectant or sanitizer does not have any additional ingredient to condition the cosmetic itself.

Phenolic derivatives have been devised as well as agents containing aldehydes, especially agents based on formaldehyde which are used for sterilization and disinfectant. These agents are most effective when they have bactericidal, fungicidal or the virucidal effect. However, the anti-bacterial action lasts for a very brief period of time so that practically immediately after disinfection, the treated article can again become contaminated.

Attempts have also been made to achieve a longer-lasting antiseptic action, for example, by emulsifying the active compounds in pads. However, it has been found that their action is of extremely limited duration because such things as dust adheres easily to the article thus destroying any antiseptic action.

Experiments with surface-active agents have also not been successful. Although quaternary ammonium compounds have an anti-bacterial action, perspiration from the skin removes the disinfectant thus leaving the consumer vulnerable.

Accordingly, it is important that the invention be easily used, easily portable and can be incorporated into a small enough container to be easily carried in the purse, in the pocket or in the briefcase.

### SUMMARY OF THE INVENTION

It is therefore an object of this invention to provide a product which can easily be applied to a cosmetic or to a cosmetic tool which sanitizes and disinfects the cosmetic and cosmetic tools.

It is a further object of the invention to produce a useful vehicle for application of a disinfectant or sanitizer to a cosmetic or a cosmetic tool which can be easily used in a retail establishment or in a home by a consumer.

It is still a further object of this invention to prevent the spread of disease by disinfecting and sanitizing cosmetics and cosmetic tools which are repeatedly used by different consumers in the marketplace.

It is therefore one of the objects of the present invention to provide a useful and easily portable solution of disinfectant and sanitizer which can be applied directly to cosmetics and which also conditions the cosmetic product. The invention may be incorporated into an appropriate vehicle such as a spray, a liquid, or a wipe which allows for portability, easy access and easy use.

To this end, one of its aspects, the invention provides a disinfectant or sanitizer for cosmetics and cosmetic tools which comprises ethyl alcohol and conditioners which condition the surface of the cosmetic and soft cosmetic tools to facilitate repeated use by different consumers with spreading harmful microorganisms.

In a further aspect of the invention, it provides a disinfectant and sanitizer for application to a cosmetic or a cosmetic tool which comprises an effective amount of ethyl alcohol and one or more conditioners for conditioning the cosmetic or cosmetic tool.

In yet a further aspect of the invention, it provides a disinfectant and sanitizer for application to a cosmetic or a cosmetic tool which comprises: 95% ethyl alcohol and one or more conditioners selected from the group consisting of isopropyl palmitate, caprylic triglyceride, capric triglyceride, isopropyl myristate and alkylbenzoate.

And yet another of its aspects, the invention provides a disinfectant and a sanitizer for application to a cosmetic or a cosmetic tool which comprises:

95% Ethyl alcohol of about 85% by weight

Isopropyl palmitate from 0 to 0.9% by weight

Caprylic triglyceride from 0 to 0.9% by weight

Capric triglyceride from 0 to 0.9% by weight

Isopropyl myristate from 0 to 0.85% by weight

Alkylbenzoate from 0 to 0.85% by weight

And yet another of its aspects, the invention provides a disinfectant and sanitizer for cosmetics and cosmetic tools admixed with a suitable vehicle.

### DETAILED DESCRIPTION OF THE PREFERRED EMBODIMENT OF THE INVENTION

This invention relates to a disinfectant or sanitizer which can be applied to the surface of a cosmetic or cosmetic tool.

The surface of a cosmetic is a good breeding ground for microorganisms including bacteria. These microorganisms can be harmful to the health of an individual and can grow on the cosmetic itself either in the home or in a retail establishment. In a home, when the consumer uses a cosmetic product, the microorganisms may grow on the cosmetic directly or may be transferred from the consumer to the cosmetic and then back to the consumer when the cosmetic product is used.

Such suitable cosmetics include lipsticks, press powders, press cakes, mascaras, eyebrow pencils, lip pencils, eye pencils, glosses and the like.

In retail establishments, many cosmetics are openly displayed. Microorganisms which circulate in the atmosphere may grow on the surface of the cosmetic or may be transferred directly to the cosmetic by a consumer. The microorganisms will then grow on the surface of the cosmetic. When the next consumer tries the cosmetic, the microorganisms which has grown significantly on the surface of the cosmetic may be transferred directly to the consumer thereby harming the health of the consumer. A similar effect can be found with respect to cosmetic tools. These include storage and display cases which are used to store and display cosmetics, scissors, files, emery boards, orange sticks, clippers, toe separators and the like. It includes any tool which is used to apply a cosmetic upon which microorganisms may grow. Microorganisms tend to grow in brushes, combs, sponges and the like and are easily transferred from a consumer to the cosmetic tool and then to another consumer when the tool is subsequently used.

The inventors have therefore invented an appropriate sanitizer and disinfectant which can be applied to the surface of the cosmetic or the cosmetic tool to “clean” the cosmetic to prevent the spread of the microorganisms to the subsequent consumer or back to the consumer. The invention comprises a disinfectant and a sanitizer admixed with a conditioner which conditions the surface of the cosmetic. The invention is then placed within a suitable vehicle.

The inventors have found that the most suitable vehicle is a spray such that when the product is sprayed on the surface of a cosmetic, it will disinfect and sanitize the surface of the cosmetic. The spray can be easily maintained by the storekeeper or by the consumer in a purse or pocket and used when desired.

The product can also be incorporated directly into a liquid which can be applied to the surface of the cosmetic.

The product may also be applied to the surface of a wipe which is conveniently packaged in an appropriate package.

Similar formulations allow the product to be applied to a cosmetic tool to prevent the spread of microorganisms.

In the preferred embodiment, the invention comprises a disinfectant or sanitizer which comprises 95% ethyl alcohol mixed with one or more conditioners for the cosmetic. The conditioners may be selected from isopropyl palmitate, caprylic triglyceride, capric triglycerides, isopropyl myristate, and alkylbenzoate in amount from 0 to 0.9% by weight.

Although the invention describes and illustrates a preferred embodiment of the invention, it is to be understood that it is not so restricted.

1. A disinfectant and sanitizer for application to cosmetics and cosmetic tools which sanitizes and disinfects said cosmetic and said cosmetic tools.

2. A disinfectant and sanitizer for cosmetics and soft cosmetic tools which comprises ethyl alcohol and conditioners which conditions the surface of the cosmetic and soft cosmetic tools.

3. A disinfectant and sanitizer for cosmetics and cosmetic tools as claimed in claim 2 wherein said conditioner is selected from the group consisting of isopropyl palmitate, caprylic triglyceride, capric triglyceride, isopropyl myristate and alkylbenzoate.

4. A disinfectant and sanitizers for cosmetics and cosmetic tools as claimed in claim 3 which comprises 95% ethyol alcohol in an amount of about 85% by weight; from 0 to 9% by weight of isopropyl palmitate; from 0 to 0.9% by weight of caprylic triglyceride; from 0 to 0.9% by weight of capric triglyceride; from 0 to 0.85% by weight of isopropyl myristate and 0 to 0.85% by weight of alkylbenzoate.

5. A disinfectant and sanitizer for cosmetics and cosmetic tools as claimed in claim 2 wherein said product is admixed with a suitable vehicle.

6. A disinfectant and sanitizer for cosmetics and cosmetic tools as claimed in claim 2 wherein said vehicle is selected from sprays, liquids and wipes.
